(19) United States
(12) Patent Application Publication
(10) Pub. No.: US 2010/0317467 A1
(43) Pub. Date: Dec. 16, 2010

(54) GOAL FOR BALL GAMES

(76) Inventors: Hubert Sørensen Freynhofer, Copenhagen (DK); Jesper Langhorn, Copenhagen (DK)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/744,352

(22) PCT Filed: Nov. 26, 2008
(86) PCT No.: PCT/EP08/66268

§ 371 Date: Aug. 30, 2010

(30) Foreign Application Priority Data
Nov. 26, 2007 (EP) 07388084.1

(51) Int. Cl. A63B 63/00; B23P 17/00; A63B 63/02

(52) U.S. Cl. 473/478; 29/401.1; 473/476

(57) ABSTRACT

A goal (1) for ball games, which is compatible with different team sizes and different ages of players, comprises a first frame (4) defining a first substantially rectangular goal opening (2) facing in a first direction and a second frame (8) defining a second substantially rectangular goal opening (3) facing in a different direction. The second goal opening has a size different from the first goal opening. Connection means (12, 13, 14, 15) connect the frames to provide a frame assembly; and a net (19) arranged to catch a ball passing through either one of the goal openings (2, 3) is attached to the frame assembly. With two different goal sizes in a double-sided goal the required storing space for multiple goal sizes is considerably reduced, and the goal just needs to be turned around in order to be ready for a game with a different team size.

### TECHNICAL FIELD OF THE INVENTION

The invention relates to a goal for ball games, which is compatible with different team sizes and different ages of players, and also to a method of modifying such a goal and a system for assembling such a goal.

### DESCRIPTION OF RELATED ART

Many ball games are played between two teams with a specified number of players on each team. However, for training purposes such games may also be played with smaller teams, and in such case goals are often used, which are smaller in size than the goals normally used for that ball game.

As an example, football (soccer) is normally played between two teams with 11 players on each team, and the goals used have a specified size. When children learn playing football, they often play with smaller teams on smaller playing fields, and accordingly they also use smaller goals. Depending on the age of the children, team sizes of e.g. three, five or seven players are typically used, and thus a corresponding number of goal sizes may be defined, which are all smaller than the normal goal for teams with 11 players.

In most football clubs there will typically be children of all ages, and thus they also need to have goals of all the different sizes, which is costly and also requires a considerable amount of space for storing all these goals.

U.S. Pat. No. 5,080,375 suggests a soccer goal assembly that is adjustable in size and shape by means of frame members that can be selected or assembled in selective lengths for the desired goal sizes. This results in a less stable goal, and it requires a time consuming adjustment procedure each time the goal is to be used for a new team size. Further, if the goal is not adjusted very carefully, the result may well be a goal, which does not have the correct dimensions for the intended team size. Also, telescoping connections in the frames defining the goal openings are generally unwanted, since a ball hitting such a connection may be bounced in an unpredictable direction.

EP 884 075 shows a double sided goal, which is adapted to be placed in the middle of a playing field so that the game is played around the goal. The sides of the goal are covered with a rebound material adapted to bounce a hitting ball to the other half of the playing field. This goal is not suitable for the use mentioned above, since it requires an even larger amount of space for storing, and is also more costly, than the well known standard goals.

FR 2 707 887 shows a modular structure having a number of different sports facilities, including two separate goals for e.g. football and handball, two basketball baskets and a rope to climb. The two goals have different sizes, and they are turned back to back with an open space between them, in which the climbing rope is arranged. They are connected to each other by an upper structure arranged above the goals and providing support for the basketball baskets and the climbing rope. Although this structure includes two goals of different size, its requirement for storing space is considerably larger than just storing two separate goals, and therefore it does not provide any solution to the problem of saving storing space. Further, the structure is very heavy and not suitable for moving around between different playing fields.

Therefore, it is an object of the invention to provide a stable goal that is compatible with different team sizes and different ages of the players, and which requires less storing space and is easy to handle, e.g. when changing from one team size to another.

### SUMMARY

According to the invention the object is achieved in that the goal comprises a first frame defining a first substantially rectangular goal opening facing in a first direction; a second frame defining a second substantially rectangular goal opening facing in a direction different from said first direction, said second goal opening having a size different from said first goal opening; connection means connecting said first and second frames to provide a frame assembly; and net means attached to said frame assembly, said net means comprising a net arranged between said first and second frames to catch a ball passing through said first goal opening and a ball passing through said second goal opening.

In this way a double-sided goal with two different goal sizes and reduced storing space requirements is achieved. With two sizes in the same goal sharing a common net the required storing space for a given number of goal sizes is considerably reduced, and when the goal has been used for a game with one team size, it just needs to be turned around in order to be ready for a game with a different team size.

It is noted that in addition to normal nets, the term net means also includes other types of material suitable to catch a ball, such as plastic materials or woven fabrics.

In one embodiment, the first and second frames are arranged in parallel planes so that the first and second goal openings face in opposite directions. This is convenient when the goal is used from both sides simultaneously.

When the net is arranged between the first and second frames in a plane parallel to the planes of the first and second frames, it is ensured that a ball hitting one of the openings does not interfere with a game played on the other side of the goal.

Each of the first and second frames may comprise a cross bar and two side posts.

The connection means may comprise a number of connection bars connecting corners of said first frame with corresponding corners of said second frame, such that said connection means and said side posts together define sides of the goal.

In one embodiment, the connection means comprises a number of connection bars, each connection bar having one end attached to said first frame and the other end attached to said second frame. This ensures a simple goal with a limited number of components, and the goal can easily be modified from one size to another.

Alternatively, the connection means may comprise a number of connection bars and at least one further frame arranged between the first and second frames in a plane parallel to the planes of the first and second frames, each end of each connection bar being attached to one of said first, second and further frames. This embodiment ensures a stable frame structure, which however requires a higher number of components.

When the connection bars are releasably attached to said frames, it is very easy and fast to modify the goal from one size to another, because one frame can easily be removed and replaced by a new one of different size.

When further the first and second frames and the connection bars comprise means enabling frames and connection bars to be assembled in different angles relative to each other, a very flexible goal is achieved, which allows frames of many different sizes to be combined in one goal.

As mentioned, the invention also relates to a method of modifying a goal as described above. The method comprises the steps of removing at least partially said net means; disengaging one of said first and second frames from said frame assembly; adjusting the position of at least some of said connection bars; connecting a new frame defining a third substantially rectangular goal opening having a size different from said first and second goal openings to the frame assembly; and attaching net means to the frame assembly.

The step of attaching net means to the frame assembly may comprise the step of reattaching the at least partially removed net means. This step is used e.g. when the net means is of a flexible material allowing the same net means to be used for different goal sizes.

Alternatively, the step of attaching net means to the frame assembly may comprise the step of replacing the at least partially removed net means by new net means.

When different lengths of connection bars are needed for different combinations of goal sizes, the method may further comprise the step of replacing at least some of said connection bars, when changing from one combination to another. Alternatively, the method may further comprise the step of adjusting at least some of said connection bars in length.

As mentioned, the invention also relates to a system for assembling a goal as described above. The system comprises at least two frames of different sizes, each frame defining a substantially rectangular goal opening; connection means for connecting two frames to provide a frame assembly; and net means arranged to be attached to said frame assembly to catch a ball passing through a goal opening.

### BRIEF DESCRIPTION OF THE DRAWINGS

The invention will now be described more fully below with reference to the drawings, in which

FIG. 1 shows one embodiment of a double sided training goal;

FIG. 2 shows the goal of FIG. 1 without the meshes of the nets being illustrated;

FIG. 3 shows a side view of the goal of FIG. 1;

FIG. 4 shows a front view of the goal of FIG. 1;

FIGS. 5 and 6 show two possibilities of connecting a connection bar to a side post of a frame;

FIGS. 7 and 8 show two examples of how nets can be attached to connection bars and frames;

FIGS. 9a to 9c show examples of how the goal of FIG. 1 can be used;

FIGS. 10a to 10f show how a goal of one size can be modified to a goal of another size;

FIG. 11 shows goal sizes standardized by FIFA;

FIG. 12 shows a goal with straight connection bars;

FIGS. 13a to 13d and 14 show further possibilities of connecting a connection bar to a side post of a frame;

FIGS. 15a to 15d show a different way of assembling the goal of FIG. 12;

FIG. 16 shows a goal with an intermediate frame;

FIG. 17 shows a side view of the goal of FIG. 16;

FIG. 18 shows a goal composed of two half goals; and

FIGS. 19a to 19e show how the goal of FIG. 18 can be modified from one size to another.

### DETAILED DESCRIPTION OF EMBODIMENTS

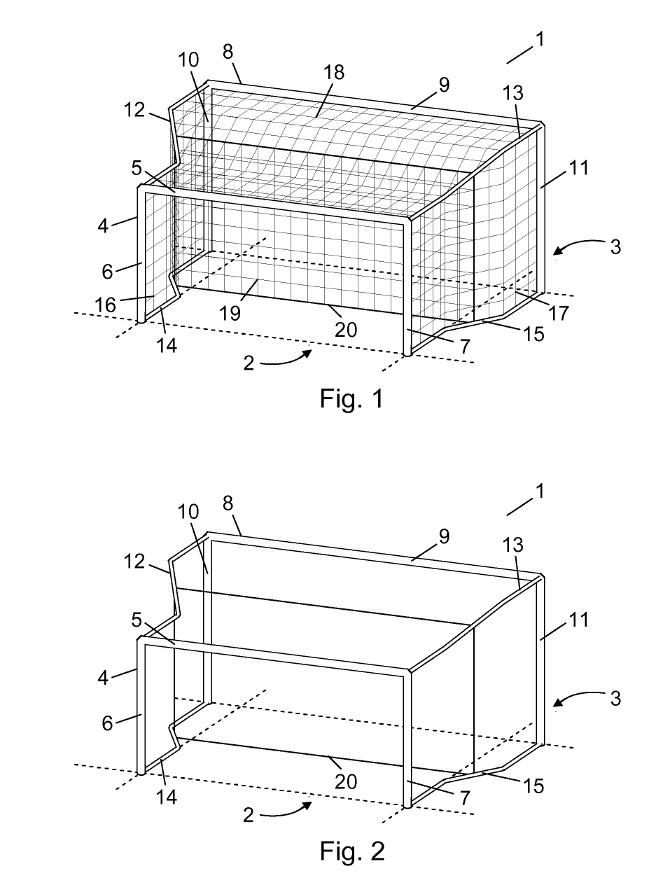

FIG. 1 shows a first example of a training device or training goal 1 according to the invention. The training device 1 is a double-sided goal having two ball receiving goal openings 2 and 3 facing in opposite directions, and it comprises a frame assembly and a number of ball stopping nets.

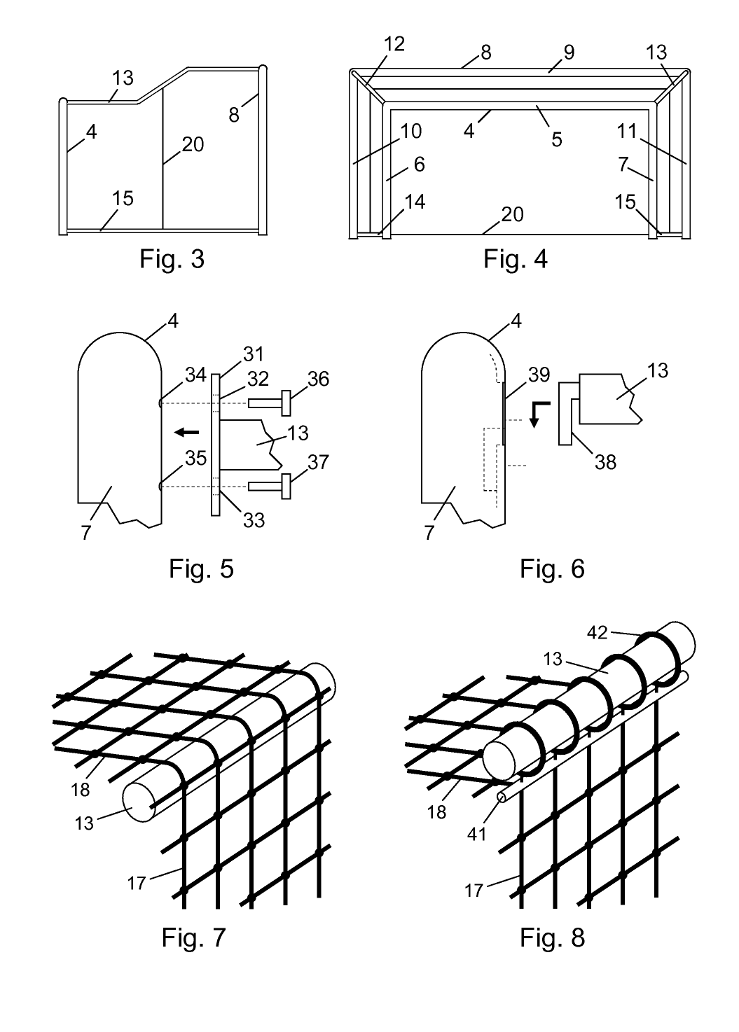

For clarity reasons, FIG. 2 shows the same training device 1 without the meshes of the nets being illustrated. Similarly, FIGS. 3 and 4 show a side view and a front view, respectively, of the device without the meshes of the nets.

Each of the two ball receiving goal openings 2 and 3 is defined by a front frame. The frame 4 defining the opening 2 is composed of a cross bar 5 and two side posts 6, 7, while the frame 8 defining the opening 3 is composed of a cross bar 9 and two side posts 10, 11. It is noted that the size of the frame 4 is different from that of the frame 8. As an example, the frame 4 can have a size corresponding to a game played by 3 persons, while the frame 8 can have a size corresponding to a game played by 5 persons.

The two frames 4, 8 are connected to each other by four connection bars 12, 13, 14, 15, so that the two frames 4, 8 and the four connection bars 12, 13, 14, 15 together form the frame assembly of the training device 1.

The two sides of the device, i.e. the areas defined by side posts 6 and 10 and connection bars 12 and 14 and by side posts 7 and 11 and connection bars 13 and 15, respectively, are covered by nets 16 and 17. Similarly, a net 18 covers the top of the device, i.e. the area defined by cross bars 5 and 9 and connection bars 12 and 13. Instead of nets, these areas may be covered by other types of materials, such as plates or sheets of e.g. metal, wood, plastic or woven fabric.

A further net 19 is arranged between the two frames 4 and 8 in a plane parallel to the planes of these frames. The purpose of the net 19 is to catch or stop a ball that is kicked or thrown through either one of the goal openings 2 or 3. Thus the net 19 is common for the two goal openings. Also this net may be replaced by other materials as mentioned above. To keep the net 19 in position, it may be provided with an edge cord 20, which in the corners of the net is connected to the connection bars 12, 13, 14, 15.

The side view in FIG. 3 and the front view in FIG. 4 clearly illustrate the different sizes of the frames 4 and 8, and also show how these frames are connected by the connection bars 12, 13, 14, 15. In these figures, the presence of the nets is only illustrated by showing the edge cord 20 of the net 19.

The frames 4 and 8 can be connected to the connection bars 12, 13, 14, 15 in different ways. FIGS. 5 and 6 illustrate two possibilities of connecting the connection bar 13 to the side post 7 of the frame 4.

In FIG. 5 the connection bar 13 is provided with a flange 31 with two through holes 32, 33, while the frame 4 correspondingly is provided with two threaded holes 34, 35. When the flange 31 is placed on the frame 4 so that the holes 32, 34 and 33, 35, respectively, are aligned, two screws or bolts 36, 37 having a thread corresponding to that of the threaded holes 34, 35 ensures a firm connection between the components. By loosening the bolts 36, 37 the frame assembly can easily be dismounted again.

In an alternative solution shown in FIG. 6 the connection bar 13 is provided with a hook 38, while the frame 4 correspondingly is provided with a vertical opening or slot 39. The hook 38 can then be inserted into the slot 39 and then moved downwards until it engages with the lower edge of the slot 39 as shown with dashed lines in the figure. To dismount the frame assembly again, the connection bar 13 is moved upwards until the hook 38 can be pulled out of the slot 39.

In addition to these examples, several other well known methods of connecting bars and frames, such as different types of fittings, can be used as well.

FIGS. 7 and 8 show two examples of how the nets 16, 17 and 18 can be attached to the connection bars 12 and 13 as well as to the frames 4 and 8.

In FIG. 7 the nets are combined to one single net having the size and form to fit over the frame assembly, so that in the corners the net is simply held in place by the connection bars 12 and 13. The figure illustrates how the combined net is placed over the connection bar 13. Alternatively, the nets may be provided with edge cords as illustrated in FIG. 8, which shows an edge cord 41 that is common for the nets 17 and 18. The edge cord 41 can then be connected to the connection bar 13 by means of a number of rings 42, which are placed on the connection bar 13 before it is connected to the two frames 4, 8 as described above. It is also possible to keep the nets in position by just arranging the connection bars through the meshes of the nets. Another solution could be to arrange a slot or a row of holes in the connection bar or the frame, in which hooks for holding the nets in position can be inserted.

As described above, the different sizes of the frames 4 and 8, and thus of the goal openings 2 and 3, make the goal well suited for games that can be played by different numbers of players and/or players of different ages. As an example, it can be mentioned that football (soccer) is normally played with 11 players on each team, but during training for children it is often played with smaller teams with e.g. 3, 5 or 7 players on each team, and the different sizes of the teams also require different sizes of the goal. The training device 1 of FIGS. 1 to 4 can be used for different team sizes. Thus, as an example, from one side the device can be used as a goal for teams with 3 players, while from the other side it can be used as a goal for teams with 5 players. Such a goal will also in the following be mentioned as a 3/5 goal.

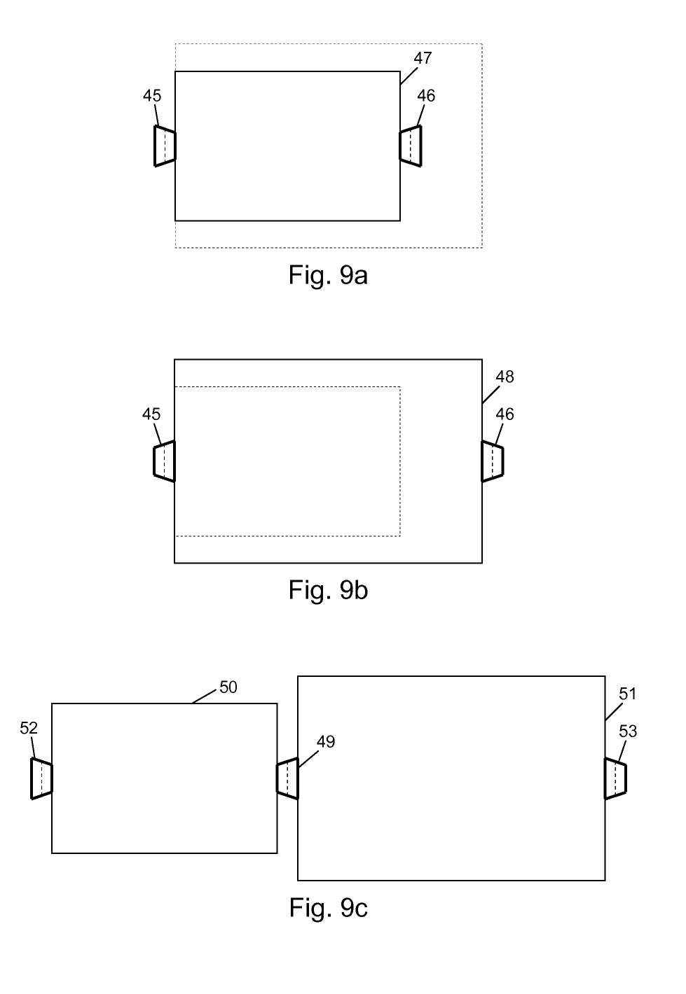

This use is illustrated in FIGS. 9a to 9c. In FIG. 9a two 3/5 goals 45 and 46 are used for teams with 3 players by placing them in each end of a corresponding playing field 47 with the smaller goal opening facing towards the playing field. When subsequently teams with 5 players on each team are going to play, the goal 45 is just turned around so that the larger goal opening is facing towards the playing field, while the goal 46 is turned around and moved to the edge of the larger playing field 48 as shown in FIG. 9b.

A goal of this type can also be used from both sides simultaneously as shown in FIG. 9c, where the goal 49 is placed between a smaller playing field 50 and a larger playing field 51. In the opposite ends of the two playing fields two other goals 52 and 53 are placed with the smaller respectively the larger goal openings facing towards the playing fields.

It is noted that the position of the net 19 may be adjustable, so that when the larger goal opening is facing towards the playing field the net can be moved towards the smaller goal opening to allow more space for the goalkeeper, and vice versa when the smaller goal opening is facing towards the playing field. When both goal openings are used simultaneously, the net can be placed in a middle position.

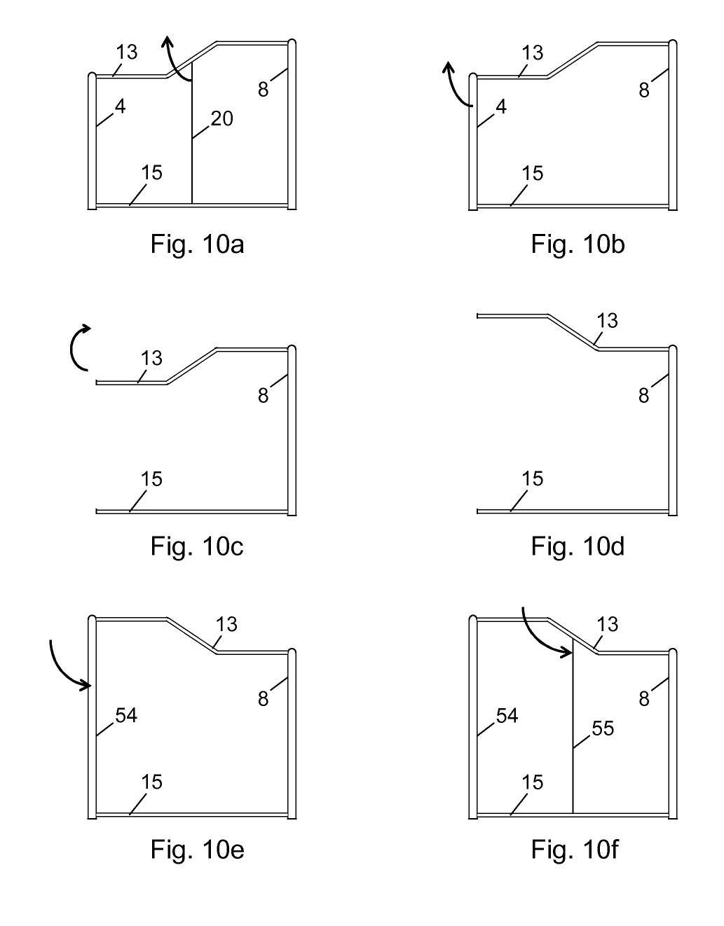

As mentioned above, the training device 1 of FIGS. 1 to 4 may be assembled in such a way that it can easily be dismounted again. This means that storage of the device when not in use is significantly facilitated, but it also results in a very flexible device, which can easily be changed in size. If e.g. the players of a team have grown older and/or become more experienced, it could be relevant to replace the 3/5 goal by a 5/7 goal, i.e. a goal that from one side can be used as a goal for teams with 5 players and from the other as a goal for teams with 7 players. Instead of having to purchase a complete new device, with the device of FIGS. 1 to 4 it will be sufficient to purchase a new frame and possibly a new set of nets, while the remaining components can be reused. FIGS. 10a to 10f illustrate how a 3/5 goal can be modified to a 5/7 goal. Again in these figures, the presence of the nets is just illustrated by indicating the edge cord 20 of the net 19.

First, in FIG. 10a the nets are removed from the goal. Then the frame 4, i.e. the frame having the size corresponding to a team with 3 players, is disengaged from the connection bars and removed as illustrated in FIG. 10b. The position of the connection bars 12, 13, 14, 15 can then be changed as illustrated for connection bar 13 in FIGS. 10c and 10d, such that the free ends of these bars are ready to receive a new and larger frame. The bars may also be turned around so that the ends previously connected to the frame 4 are now connected to the frame 8. In FIG. 10e a new frame 54 having the size corresponding to a team with 7 players is connected to the connection bars, and finally a new set of nets can be attached, which in FIG. 10f is illustrated by indicating an edge cord 55 of a new and larger net. Instead of using a new and larger set of nets, the nets may be made of a flexible material, so that the original set of nets can be re-used for the larger goal. The previous 3/5 goal has then been modified to a 5/7 goal. It is noted that for some embodiments, depending on the method of attaching the nets, the nets might have to be put in place before the frame 54 is mounted. It is also noted that the reuse of the connection bars 12, 13, 14, 15 put some restrictions on the dimensions of the new frame. If these restrictions are not fulfilled, it might also be necessary to replace two of the connection bars by some of a different length, or connection bars adjustable in length can be used. However, also in such case the modification of an existing goal to a different size will still be much cheaper than having to purchase a complete new goal.

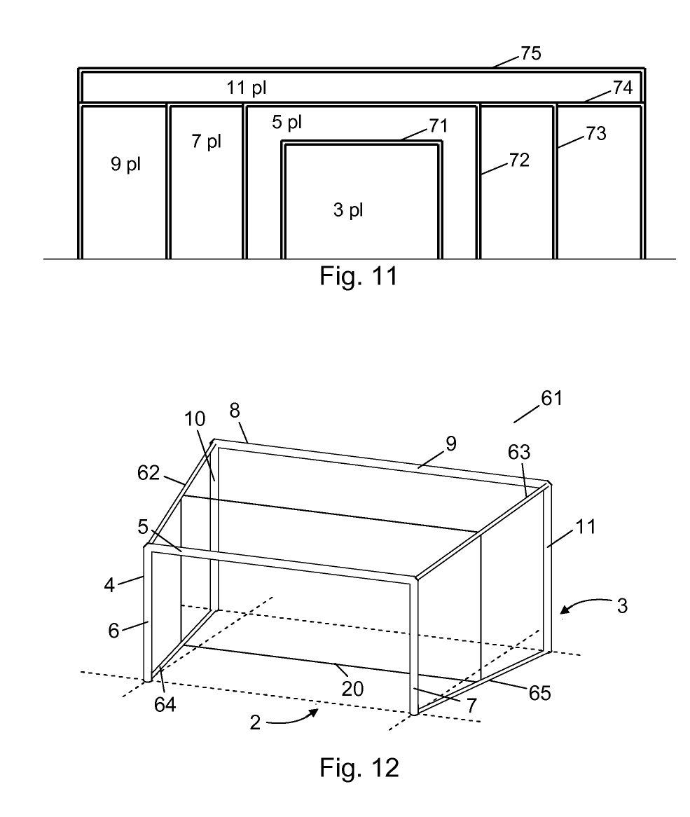

The dimensions of the different frames may of course vary dependent on the type of game or play for which the device is to be used. As an example, the “Fédération Internationale de Football Association” (FIFA) has standardized a number of goal sizes for the training of children. These goal sizes are illustrated in FIG. 11. The smallest goal size 71 is 1.5 m high and 2.0 m wide and is used for players of age five and six years playing with three players on each team. Players from seven to ten years old play with five players on each team, and the corresponding goal 72 is 2.0 m high and 3.0 m wide. Players from ten to 12 years old play with seven players on each team, and the corresponding goal 73 is 2.0 m high and 5.0 m wide. Players from 12 years and up play with 11 players on each team, and they use the normal goal size 75 that is 2.44 m high and 7.32 m wide. However, a further goal size 74, which is 2.0 m high and 7.32 m wide, has been proposed for players of age 11 to 13 years playing with nine players on each team. Thus if the device 1 of FIGS. 1 to 4 is a 3/5 goal according to this standard, the frame 4 will have the goal size 71 (1.5 m times 2.0 m) while the frame 8 will have the size 72 (2.0 m times 3.0 m). When the device is modified to a 5/7 goal as illustrated in FIGS. 10a to 10f, the frame 4 is replaced by the new frame 54 of size 73 (2.0 m times 5.0 m). In this case the frames 8 and 54 have the same height (in contrast to FIGS. 10e and 10f), and most expediently all four connection bars 12, 13, 14, 15 should have the same length. Since this is not the case for the original 3/5 goal, two of them should either be replaced or they could be adjustable in length.

The double sided goal described above is as mentioned one example of how a device according to the invention can be embodied. Thus the device may be modified in several ways. FIG. 12 shows a goal 61 in which straight connection bars 62, 63, 64, and 65 are used in stead of the bent connection bars 12, 13, 14, and 15 in the goal 1 of FIGS. 1 to 4. The remaining components of the goal 61 are the same as those of the goal 1. The connection bars may also have many other shapes.

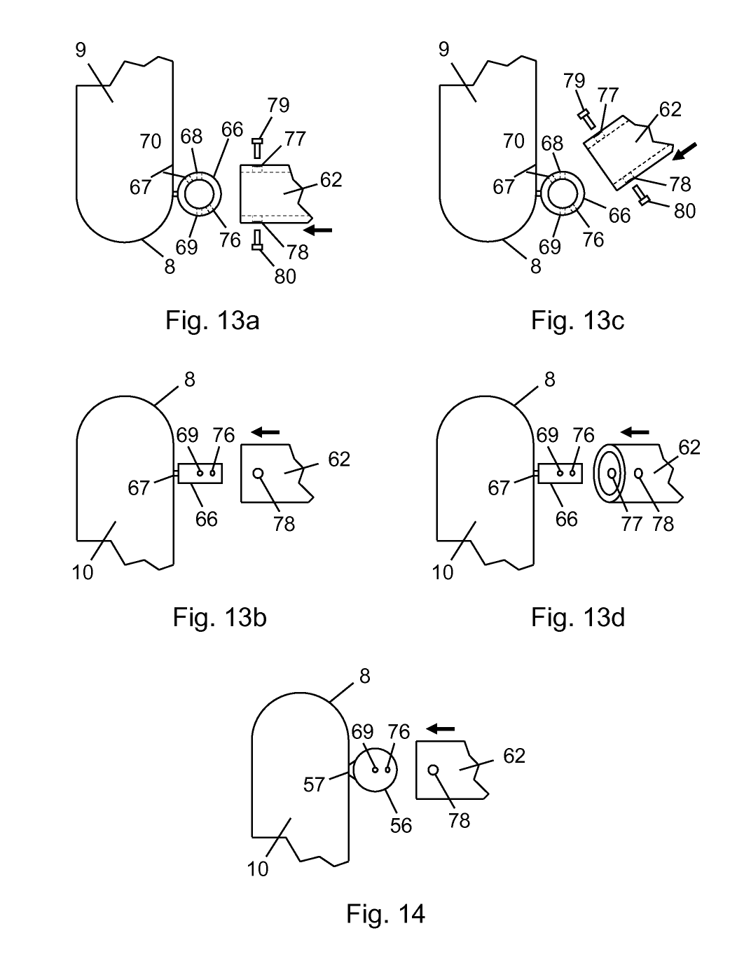

It is noted that in the goal 61 of FIG. 12, the connection bars 62, 63, 64, and 65 are not connected to the frames 4 and 8 at right angles as it was the case for the goal 1 of FIGS. 1 to 4. The connection methods described above can still be used, also for oblique angles. In e.g. FIG. 5, the holes 34 and 35 may be arranged differently in the frame 4, and/or the flange 31 may be arranged obliquely at the end of the connection bar 13. Another way of connecting the frames and the connection bars in case of oblique angles is shown in FIGS. 13a to 13d.

In FIGS. 13a (top view) and 13b (side view) a ring member 66 is attached to e.g. the frame 8, either directly or through a connecting element 67. It may be firmly and permanently connected to the frame, e.g. by welding or gluing, or it may be mounted e.g. by means of fittings. The ring member 66 is provided with a first set of threaded holes 68, 69 aligned with each other and arranged on opposite sides of the ring member, and similarly a second set of aligned threaded holes 70, 76 arranged on opposite sides of the ring member, but at an angle different from that of the first set of threaded holes. The connection bar 62, which is here tubular, is provided with two through holes 77, 78.

When the connection bar 62 is to be connected to the frame in a right angle, the ring member 66 is inserted into the tubular connection bar as shown in FIGS. 13a and 13b so that the holes 77, 78 are aligned with the first set of threaded holes 68, 69, and two screws or bolts 79, 80 having a thread corresponding to that of the threaded holes 68, 69 ensures a firm connection between the components.

If instead the connection bar is to be connected to the frame in an oblique angle in the horizontal plane, as it is the case e.g. for the connection bars 64, 65 in FIG. 12, the ring member 66 is inserted into the tubular connection bar so that the holes 77, 78 are aligned with the second set of threaded holes 70, 76 as shown in FIGS. 13c and 13d. Again a firm connection is ensured by the bolts 79, 80.

If the connection bar should also be mounted in an oblique angle in a vertical plane, as it is the case e.g. for the connection bars 62, 63 in FIG. 12, the connection bar can just be turned in the vertical plane to the required position before tightening the bolts 79, 80.

For clarity reasons, only two sets of threaded holes, i.e. holes 68, 69 and 70, 76, respectively, have been shown in FIGS. 13a to 13d. In a practical solution, however, several sets of threaded holes can be arranged in the ring member 66 to allow the connection bars to be mounted in several different angles or positions as required by different goal sizes.

As an alternative to the ring member 66, a spherical connection member 56 may be used, as illustrated in FIG. 14. This allows a more flexible arrangement of the threaded holes. Similarly to the ring member 66, the spherical connection member 56 may be connected to the frame through a connecting element 57.

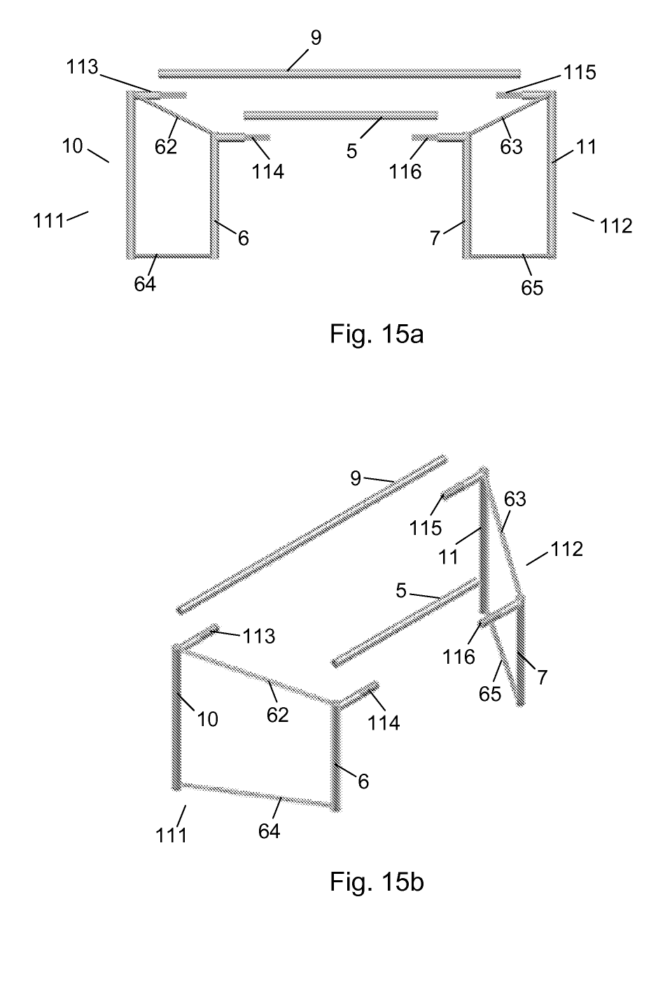

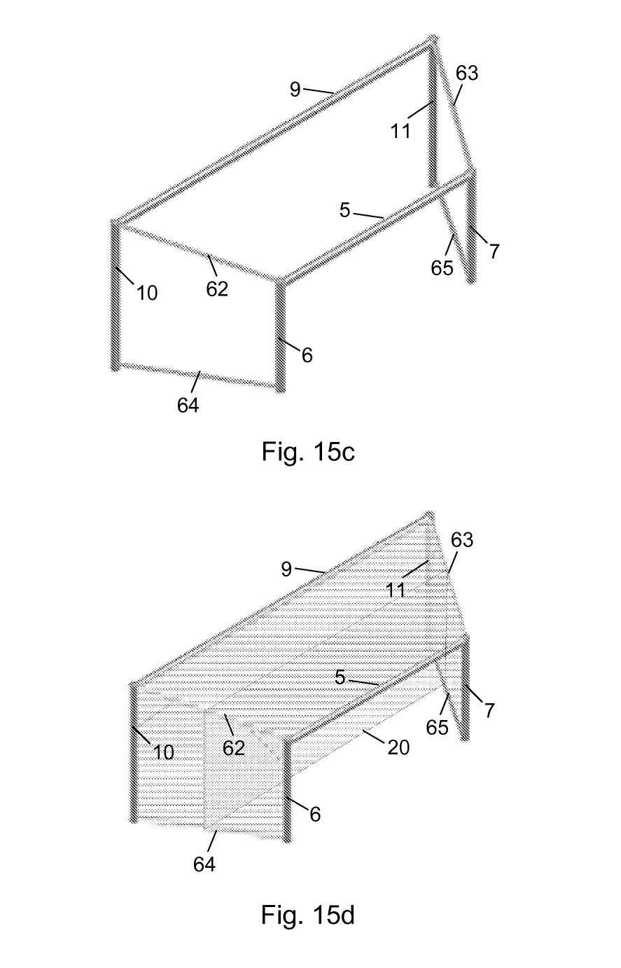

A different way of assembling the goal 61 of FIG. 12 is illustrated in FIGS. 15a to 15d. As it can be seen in the front view in FIG. 15a and the perspective view in FIG. 15b, connection bars 62, 64 and side posts 6, 10 are firmly connected, e.g. by welding or gluing, to form a side frame 111. Similarly, another side frame 112 is formed by connection bars 63, 65 and side posts 7, 11. In this case the cross bars 5, 11 are tubular, at least in their end portions. In each upper corner of the side frames 111 and 112 a pin is arranged, i.e. the pins 113 and 114 on side frame 111 and the pins 115 and 116 on the side frame 112. The pins may e.g. be welded or glued to the side frames. As shown in the figures, each pin may comprise a section having the same diameter as the cross bars 5 and 9 and a thinner section to be inserted into the tubular ends of the cross bars. In that case the length of each cross bar is a corresponding bit shorter than the width of corresponding goal opening. Alternatively, the pins may only comprise the thinner section to be inserted into the tubular ends of the cross bars, in which case the length of each cross bar corresponds to the width of the goal opening in which it is used. To assemble the goal, each pin is simply inserted into the corresponding tubular end of one of the cross bars. The assembled goal is then shown in FIG. 15c, and FIG. 15d shows the goal when also the nets are arranged. This goal corresponds to the goal 61 in FIG. 12.

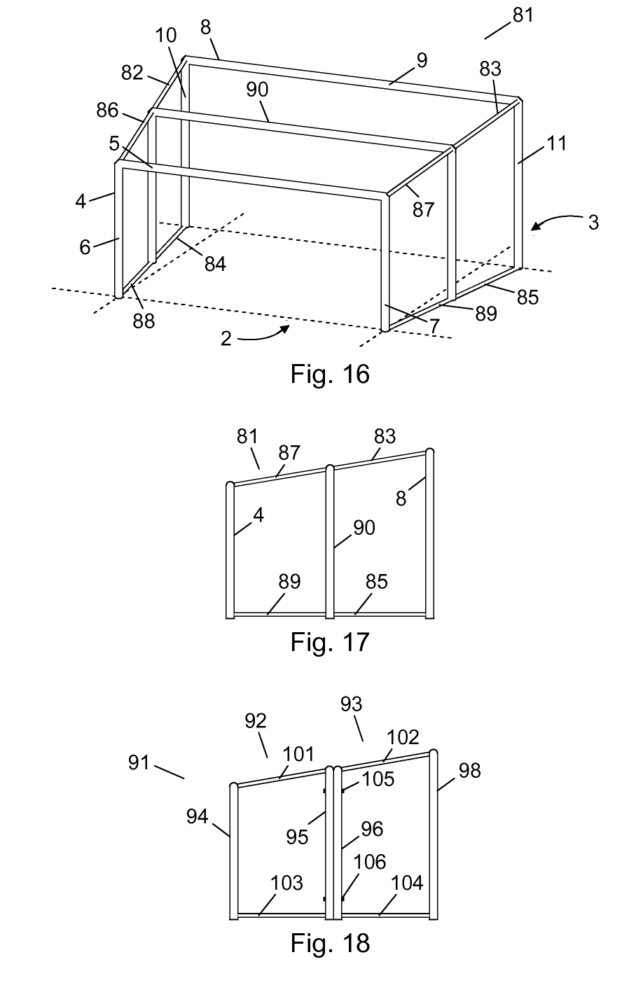

Another embodiment is shown in FIGS. 16 and 17. In addition to the two frames 4 and 8 the goal 81 has a further frame 90 arranged between the two other frames. The three frames are connected by eight connection bars 82, 83, 84, 85, 86, 87, 88, and 89. A net corresponding to the net 19 of FIG. 1 and arranged to catch a ball that is kicked or thrown through one of the openings 2 and 3 can then easily be attached to the frame 90. In FIGS. 16 and 17 the intermediate frame 90 has a size between the sizes of the frames 4 and 8, but alternatively, the frame 90 could also have the same size as one of the other two frames, or even be larger than them both. When changing one of the frames to a different size, the intermediate frame 90 can either be kept as it is or it can be changed as well.

A further embodiment is shown in FIG. 18, where the double goal 91 shown in side view has two intermediate frames 95 and 96. Thus the goal 91 can be said to be composed of two “half goals” 92 and 93, which can be assembled separately. Half goal 92 is assembled of a front frame 94, an intermediate frame 95 and four connection bars of which connection bars 101 and 103 can be seen in the figure. Although not shown, half goal 92 may be covered by nets, so that only the goal opening defined by the front frame 94 is left open. Similarly, half goal 93 is assembled of a front frame 98, an intermediate frame 96 and four connection bars of which connection bars 102 and 104 can be seen in the figure, and half goal 93 may be covered by nets, so that only the goal opening defined by the front frame 98 is left open. Each half goal may be assembled as described above, or the frames and the connection bars may be more permanently connected to each other. The two half goals 92 and 93 are assembled to the double goal 91 by e.g. bolts 105, 106 or similar assembling means. Again, frames 94 and 98 have different sizes, so that e.g. a 3/5 goal corresponding to those described above is created. Also for this embodiment, the intermediate frames 95 and 96 may have other dimensions as those indicated in the figure, and the connection bars may have other shapes.

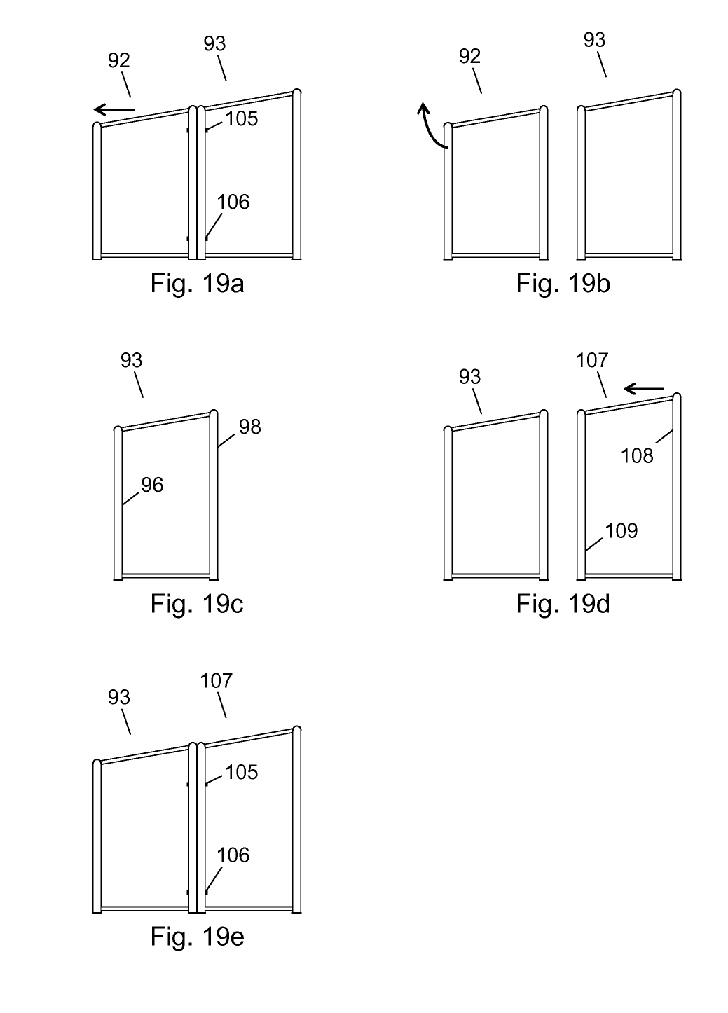

FIGS. 19a to 19e illustrate how the double goal 91 can be changed to a goal of different size. First, as shown in FIGS. 19a and 19b, the bolts 105 and 106 are removed to separate the two half goals, and half goal 92 can then be removed, while half goal 93 is maintained as shown in FIG. 19c. Although not shown in the figure, the nets can now be changed, so that the frame 96, which in the original goal was an intermediate frame, but will now be a front frame, is left open. A new half goal 107 with frames 108 and 109, of which frame 108 is left open, is then placed next to the half goal 93 as shown in FIG. 19d, and finally the two half goals 93 and 107 are assembled to a new double goal with the bolts 105 and 106 as shown in FIG. 19e.

Although various embodiments of the present invention have been described and shown, the invention is not restricted thereto, but may also be embodied in other ways within the scope of the subject-matter defined in the following claims.

1. A goal for ball games, which is compatible with different team sizes and different ages of players, the goal comprising:
a first frame defining a first substantially rectangular goal opening facing in a first direction;
a second frame defining a second substantially rectangular goal opening facing in a direction different from said first direction, said second goal opening having a size different from said first goal opening;
connection means connecting said first and second frames to provide a frame assembly; and
net means attached to said frame assembly, said net means comprising a net arranged between said first and second frames to catch a ball passing through said first goal opening and a ball passing through said second goal opening.

2. A goal according to claim 1, wherein said first and second frames are arranged in parallel planes so that the first and second goal openings face in opposite directions.

3. A goal according to claim 2, wherein said net is arranged between the first and second frames in a plane parallel to the planes of the first and second frames.

4. A goal according to claim 1, wherein each of said first and second frames comprises a cross bar and two side posts.

5. A goal according to claim 4, wherein said connection means comprises a number of connection bars connecting corners of said first frame with corresponding corners of said second frame, such that said connection means and said side posts together define sides of the goal.

6. A goal according to claim 1, wherein said connection means comprises a number of connection bars, each connection bar having one end attached to said first frame and the other end attached to said second frame.

7. A goal according to claim 1, wherein said connection means comprises a number of connection bars and at least one further frame arranged between the first and second frames in a plane parallel to the planes of the first and second frames, each end of each connection bar being attached to one of said first, second and further frames.

8. A goal according to claim 6, wherein said connection bars are releasably attached to said frames.

9. A goal according to claim 8, wherein said first and second frames and said connection bars comprise means enabling frames and connection bars to be assembled in different angles relative to each other.

10. A method of modifying a goal according to claim 1, the method comprising the steps of:
removing at least partially said net means;
disengaging one of said first and second frames from said frame assembly;
adjusting the position of at least some of said connection bars;
connecting a new frame defining a third substantially rectangular goal opening having a size different from said first and second goal openings to the frame assembly; and
attaching net means to the frame assembly.

11. A method according to claim 10, wherein the step of attaching net means to the frame assembly comprises the step of reattaching the at least partially removed net means.

12. A method according to claim 10, wherein the step of attaching net means to the frame assembly comprises the step of replacing the at least partially removed net means by new net means.

13. A method according to claim 10, wherein the method further comprises the step of replacing at least some of said connection bars.

14. A method according to claim 10, wherein the method further comprises the step of adjusting at least some of said connection bars in length.

15. A system for assembling a goal according to claim 1, the system comprising:
at least two frames of different sizes, each frame defining a substantially rectangular goal opening;
connection means for connecting two frames to provide a frame assembly; and
net means arranged to be attached to said frame assembly to catch a ball passing through a goal opening.
